(19) United States
(12) Patent Application Publication
(10) Pub. No.: US 2003/0139487 A1
(43) Pub. Date: Jul. 24, 2003

(54) Radiation-curable compositions and related methods for the assembly and repair of optical components and products prepared thereby

(75) Inventors: Eva I. Montgomery, Woodstock, IL (US); Kenneth Dake, South Elgin, IL (US); Vadim V. Krongauz, Bartlett, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: DSM N.V., Heerlen (NL)

(21) Appl. No.: 10/284,906

(22) Filed: Oct. 31, 2002

Related U.S. Application Data
(60) Provisional application No. 60/335,175, filed on Oct. 31, 2001.

(51) Int. Cl. C08G 2/00

(52) U.S. Cl. 522/74; 522/77

(57) ABSTRACT

Improved radiation-curable compositions and related methods useful in the assembly of optical components. These compositions cure via free-radical polymerization and comprise: about 30 to about 70 wt. % oligomer; about 10 to about 50 wt. % reactive diluent; and about 0.1 to about 40 wt. % adhesion promoter, wherein the cured composition exhibits a modulus of less than about 50 MPa, and a dry adhesion in excess of about 50 g force. A related aspect of the present invention is a higher modulus composition that cures via free-radical polymerization and comprises: about 30 to about 70 wt. % oligomer; about 10 to about 50 wt. % reactive diluent; and about 0.1 to about 40 wt. % polymerizable adhesion promoter, wherein the cured composition exhibits a modulus of greater than about 600 MPa.

### CROSS-REFERENCE TO RELATED PATENT APPLICATIONS

This patent application claims the benefit of U.S. Provisional Patent Application No. 60/335,175, filed Oct. 31, 2001, which is incorporated by reference.

### FIELD OF THE INVENTION

The present invention relates to radiation-curable compositions and related methods for the assembly and repair of optical components, such as optical fibers and photonic devices, as well as products prepared using these compositions and methods.

### BACKGROUND OF THE INVENTION

The assembly and repair of optical components, such as optical fibers and photonic devices, desirably includes the use of radiation-curable compositions as coating materials and adhesives. The success of these compositions over the years is based in part on their speed of cure (typically no more than a few seconds), low cost, and ability to cure at room temperature, without the application of heat.

In a typical optical glass fiber manufacturing process, two or more superimposed radiation-curable coatings are applied onto a glass fiber, also referred to as a waveguide, after the glass fiber is produced by drawing in a furnace. Together, these coatings are commonly referred to as a primary coating. The first coating, which directly contacts the glass surface, is called the inner primary coating. The second, an overlaying coating, is called the outer primary coating. In older references, the inner primary coating was often called simply the primary coating, and the outer primary coating was called a secondary coating. That terminology has been abandoned by the optical fiber industry in recent years. Single-layered coatings (single coatings) can also be used to coat glass fibers. Single coatings generally have properties (e.g., hardness) which are intermediate to the properties of the softer inner primary and harder outer primary coatings.

In the two coating systems, the relatively soft inner primary coating provides resistance to microbending. The latter, when present, contributes to undesirable attenuation of the signal transmission capability of the fiber. The relatively harder outer primary coating provides resistance to handling forces, such as those encountered when the coated fiber is ribboned and/or cabled.

Optical fiber coating compositions, whether they are inner primary coatings, outer primary coatings, or single primary coatings, generally comprise, before cure, a polyethylenically unsaturated monomer or oligomer dissolved or dispersed in a liquid ethylenically unsaturated medium and a photoinitiator. The coating composition is typically applied onto the fiber in liquid form and then exposed to actinic radiation to effect cure.

Coated optical fibers, whether containing glass or, as has come into use more recently, plastic, are usually colored to facilitate identification and segregation of individual coated optical fibers. Typically, optical fibers are coated with an outer colored layer, referred to as an ink, to provide coloration. Alternatively, a colorant may be added to the inner or outer primary coating to impart the desired color to the finished fiber.

For multi-channel transmission, optical fiber assemblies containing a plurality of coated optical fibers have been used. Examples of optical fiber assemblies include ribbon assemblies and cables. A typical ribbon assembly is made by bonding together a plurality of parallel-oriented, individually coated, optical fibers with what is generally referred to as a matrix material. The matrix material has the function of holding the individual optical fibers in alignment and protecting the fibers during handling and installation. Often, the fibers are arranged in tape-like ribbon structures, having a generally flat, strand-like structure containing generally from about 2 to 24 fibers. An example of a ribbon assembly is described in published European Patent Application No. 194891. Depending upon the application, a plurality of ribbon assemblies can be combined into a cable, the latter including from several up to about one thousand individually coated optical fibers, e.g., U.S. Pat. No. 4,906,067.

In use, ribbon assemblies and cables are installed in a variety of locations, ranging from underground conduits to electrical conduits within the walls of buildings. As the assemblies are handled and installed, one or more of the coatings can sustain damage. Assemblies having optical fibers with damaged inner or outer primary coatings can exhibit unacceptable deterioration of data transmission.

Moreover, many optical fiber installations require the splicing of one (or more) individual fibers within a first ribbon assembly to one (or more) individual fibers in a second ribbon assembly. For example, splicing is typically necessary when adding a new user, or group of users, to an existing optical cable, or when replacing a damaged section of an assembly, e.g., subsequent to an industrial accident, excavation error, damage inflicted by force of nature. Generally, splicing requires the removal of the existing, factory-applied coating on each fiber. Thereafter, the glass (or plastic) waveguides in the first and second assemblies are fused. The splicing is completed by applying a liquid radiation-curable splicing composition onto the bare glass (or plastic) surface, overlapping onto the adjacent factory-applied coating. The result, after curing of the coating, is a “recoated” optical fiber. The radiation-curable compositions used in splicing are thus also referred to as optical fiber recoats, or recoating compositions.

Because the recoating compositions are applied directly onto the waveguide and cured coatings, they must meet minimum standards for inner primary coating compositions, offer the protective aspects of the outer primary coating, and adhere to both the waveguide surface and existing factory-applied coating. Further, as splicing occurs in the field, the recoats must also cure relatively quickly using available hand-held radiation sources, and have properties that permit ease of application by a field technician. While existing recoating compositions are adequate for most optical fiber splicing and repair applications, recoating compositions having improved properties and performance are desired.

The assembly of photonics devices requires compositions which are able to adhere various components to one another, and which provide some degree of protection thereto when applied as a coating. For example, relatively transparent components, such as lenses, optical fibers, filters and the like, are required to be joined. The composition used to assemble these components, however, should cure quickly and reliably, be inexpensive, and should not unduly impact the performance of the device.

A need therefore exists for radiation-curable compositions and related methods for the assembly of optical components, such as optical fibers and photonics device components, wherein the compositions and methods provide enhanced performance and greater ease of use relative to existing radiation-curable compositions and methods, as further described herein.

### SUMMARY OF THE INVENTION

One aspect of the present invention provides improved radiation-curable compositions and related methods useful in the assembly of optical components. These compositions cure via free-radical polymerization and comprise: about 30 to about 70 wt. % oligomer; about 10 to about 50 wt. % reactive diluent; and about 0.1 to about 40 wt. % adhesion promoter, wherein the cured composition exhibits a modulus of less than about 50 MPa, and a dry adhesion in excess of about 50 g force. A related aspect of the present invention is a higher modulus composition that cures via free-radical polymerization and comprises: about 30 to about 70 wt. % oligomer; about 10 to about 50 wt. % reactive diluent; and about 0.1 to about 40 wt. % polymerizable adhesion promoter, wherein the cured composition exhibits a modulus of greater than about 600 MPa.

Another aspect of the present invention provides radiation-curable compositions that enable a user to readily confirm that the radiation-curable composition has been properly cured. These compositions also cure via free-radical polymerization and comprise: an oligomer; a reactive diluent; and a substantially-colorless dye precursor, wherein the curable composition, which is substantially-colorless prior to curing, becomes colored upon exposure to curing radiation.

The foregoing inventive compositions may be used in connection with the assembly of optical components, e.g., splicing optical fibers, joining various components of photonics devices, coatings for photonics devices. A related aspect of the present invention thus contemplates methods for assembling optical components using the foregoing compositions. An example of one such method, which uses the composition containing a substantially-colorless dye precursor, comprises: (a) applying, between two optical components, a radiation-curable composition which cures via free-radical polymerization, the composition being substantially-colorless prior to curing and comprising: (i) an oligomer; (ii) a reactive diluent; and (iii) a substantially-colorless dye precursor, and (b) exposing the composition to curing radiation, wherein the composition becomes colored upon exposure to curing radiation.

The present invention further contemplates, as yet another aspect, assembled optical components which include the inventive radiation-curable compositions described herein.

The various aspects of the present invention described in the following paragraphs are set forth with an emphasis on preferred embodiments. However, it will be obvious to those of ordinary skill in the art that variations of the preferred embodiments may be successfully used. The inventive compositions, methods and assemblies should therefore not be construed as being limited to the following preferred embodiments, but as including alternatives to these specifically described herein.

### DETAILED DESCRIPTION OF THE PREFERRED EMBODIMENTS

One aspect of the present invention provides improved radiation-curable compositions, and related methods useful in the assembly of optical components, and optical assemblies containing these compositions.

These compositions cure via free-radical polymerization and comprise: about 30 to about 70 wt. % oligomer; about 10 to about 50 wt. % reactive diluent; and about 0.1 to about 40 wt. % adhesion promoter, wherein the cured composition exhibits a modulus of less than about 50 MPa, and a dry adhesion in excess of about 50 g force. A related aspect of the present invention is a higher modulus composition that cures via free-radical polymerization and comprises: about 30 to about 70 wt. % oligomer; about 10 to about 50 wt. % reactive diluent; and about 0.1 to about 40 wt. % polymerizable adhesion promoter, wherein the cured composition exhibits a modulus of at least about 600 MPa.

The foregoing compositions, and particularly the relatively low modulus composition, may be used, for example, as optical fiber recoating compositions. When used for this purpose, enhanced performance in-the cured composition relative to existing recoating compositions is exhibited. For example, in the relatively low modulus compositions, the dry adhesion (e.g., adhesion onto a glass surface) of the cured composition is enhanced relative to known recoating compositions.

The modulus (of elasticity) referred to herein, as is well known, may be determined from a plot of the strain in a given material as a function of the stress applied thereto. More specifically, the modulus herein is represented graphically as the straight line portion of a stress-strain diagram (i.e., where the secant modulus remains substantially constant). The modulus may be determined by the use of any instrument suitable for providing a stress-strain curve of a sample, in the present case, a cured sample prepared from the subject radiation-curable materials described herein. Instruments suitable for this analysis include those manufactured by Instron Corporation (Canton, Mass.), and include the Instron 5564, 4442 and 4201.

In determining the modulus of the cured materials, a sample of a radiation-curable material is drawn onto a plate to provide a thin film. The sample is then exposed to radiation to affect cure. One (or more, if an average value is desired) film sample is cut from the cured film. The sample(s) should be free of significant defects, e.g., holes, jagged edges, substantial non-uniform thickness. Opposite ends of the sample are then attached to the instrument, and testing is commenced.

During testing, a first end of the sample remains stationary, while the instrument moves (pulls) the second end away from the first end at what may be referred to as a crosshead speed. The crosshead speed, which can be varied depending on the type of sample undergoing testing, initially should be set at 1 inch/minute. After testing of a sample is completed, the instrument provides a stress-strain curve, determines the modulus (commonly via the software package included with the instrument), and other data provided.

Turning now to the components of the radiation-curable compositions of the present invention, the compositions include components that have one or more functionalities (or functional groups) which, as their name implies, cure upon exposure to radiation, and preferably upon exposure to ultra-violet (UV) radiation. One general class of radiation-curable functionality is ethylenic unsaturation. Components that include this functionality, in general, may be cured via free radical polymerization. Illustrative of functional groups that are ethylenically unsaturated include (meth)acrylate (i.e., methacrylate or acrylate), styrene, vinylether, vinyl ester, N-substituted acrylamide, N-vinyl amide, maleate ester, and fumarate ester.

The majority of the components included in the inventive radiation-curable compositions may be conveniently categorized as oligomers, reactive diluents or adhesion promoters.

The oligomers are typically of relatively high viscosity and molecular weight, the latter advantageously ranging above about 700, preferably above about 5,000 and most preferably above about 10,000 Daltons. In contrast, the reactive diluents commonly constitute relatively low molecular weight components which, as their name implies, function to dilute and thereby lower the viscosity of the compositions to levels acceptable to optical component assemblers. For example, sufficient diluent may be added to adjust the viscosity of the compositions to from about 500 cps to about 3000 cps (at 25° C.). The adhesion promoters, which will be further described herein, are available as polymerizable and non-polymerizable components, and provide the function for which they are named.

In the context of oligomers and reactive diluents, the inventive compositions generally contain from about 20 wt. % to about 60 wt. % oligomers, with oligomers desirably constituting a majority of the curable composition. Preferably, the oligomers comprise at least about 40 wt. %, and more preferably at least about 50 wt. %, of the curable composition. The reactive diluents are generally included in amounts ranging from about 10 wt. % to about 50 wt. %, but are desirably limited to about 20 wt. % to about 50 wt. %, and more desirably to about 30 wt. % to about 40 wt. % of the curable composition. On a weight ratio basis, the oligomer to reactive diluent ration desirably ranges from about 1.5:1 to about 4:1, and preferably about 2:1 to about 3:1.

The foregoing oligomers and reactive diluents are commercially available with one, two, three, or more, radiation-curable functionalities. Generally, and among other considerations, one will adjust the amount of each type of component, and within these components the number of radiation-curable functionalities, to provide the desired properties in the cured composition. For example, multifunctional components, and particularly those components having at least three radiation-curable functionalities, enhance the modulus of the cured composition.

In view of the properties desired in the relatively low modulus inventive compositions (below about 50 MPa), the amount of components having at least three functionalities is desirably very limited preferably less than about 15 wt. %, and more preferably less than about 10 wt. % of the curable composition. In comparison, the relatively high modulus compositions may include at least about 20 wt. %, advantageously at least about 40 wt. %, and up to about 60 wt. %, of these multifunctional components.

Oligomers useful in the inventive compositions include a carbon-containing backbone structure to which the radiation-curable functional group(s) are bound. The size of the carbon-containing backbone is preferably selected to provide the desired molecular weight, which in turn affects at least the modulus of the cured composition. The number average molecular weight of the oligomer desirably ranges from about 200 to about 30,000, preferably ranges from about 500 to about 7,000, and most preferably ranges from about 1,000 to about 5,000.

Illustrative of suitable carbon-containing polymerizable backbones include a polymerizable backbone of a polyether, a polyolefin, a polyester, a polyamide, a polycarbonate, an alkyd, or mixtures thereof. The oligomers are desirably selected to affect the hydrolytic stability of the cured composition. In this regard, oligomers containing polyether backbones are preferred because they are relatively low in cost, readily available and promote reasonable levels of hydrolytic stability.

The hydrolytic stability of a cured composition may be determined by comparing the weight of a cured film both before and after exposure to an 85° C./85% relative humidity environment for at least 4 weeks, and calculating the percent reduction in weight experienced upon exposure to the environment. Desirably, the cured film will experience less than about 15% weight loss, and preferably less than about 10%, wherein a low weight loss number correlates to a high degree of hydrolytic stability. The hydrolytic stability may also be evaluated by determining the equilibrium modulus of a cured film (by conducting Dynamic Mechanical Analysis). In this analysis, the greater the equilibrium modulus, the greater the hydrolytic stability. Preferred compositions meet a combination of the foregoing hydrolytic stability tests, i.e., equilibrium modulus and weight reduction, at the previously recited levels.

Backbones that are most desirable include polyethers and urethane acrylate systems, although polyesters and thiol-ene and epoxy-type systems may also be employed.

Reactive diluents suitable for use in the inventive compositions include those components having a C₄-C₂₀ alkyl or polyether moiety. Illustrative of these reactive diluents include: hexylacrylate, 2-ethylhexylacrylate, isobornylacrylate, decyl-acrylate, laurylacrylate, stearylacrylate, 2-ethoxyethoxyethylacrylate, laurylvinylether, 2-ethylhexylvinyl ether, N-vinyl formamide, isodecyl acrylate, isooctyl acrylate, vinyl-caprolactam, N-vinylpyrrolidone, acrylamides, trimethylpropanetriacrylate, mixtures thereof, and the like.

Another type of reactive diluent that may be used is a compound having an aromatic group. Particular examples of reactive diluents having an aromatic group include: ethyleneglycolphenyletheracrylate, phenoxyethylacrylate, polyethyleneglycolphenyletheracrylate, polypropyleneglycolphenyletheracrylate, and alkyl-substituted phenyl derivatives of the above monomers, such as polyethyleneglycolnonylphenyletheracrylate, and mixtures thereof.

The reactive diluent can also comprise a diluent having two or more functional groups capable of polymerization. Particular examples of such monomers include: C₂-C₁₈ hydrocarbondioldiacrylates, C₄-C₁₈ hydrocarbondivinylethers, C₂-C₁₈ hydrocarbondioltriacrylates, and the polyether analogues thereof, and the like, such as 1,6-hexanedioldiacrylate, hexanedioldivinylether, triethyleneglycoldiacrylate, ethoxylated bispheno-A diacrylate, and tripropyleneglycol diacrylate, and mixtures thereof.

An adhesion promoting component is a further desirable component of the inventive curable compositions. As its name implies, these promoters function to enhance the adhesion of the cured composition to a substrate. For example, when the composition is used as a recoating material, these promoters enhance the adhesion of the cured coating to the surface of the waveguide and existing factory-applied coating.

The adhesion promoters can be conveniently segregated into two groups: polymerizable and non-polymerizable adhesion promoters. Generally, the polymerizable adhesion promoters are included to promote adhesion of both relatively high modulus compositions (above about 600 MPa) and relatively low modulus compositions (below about 50 MPa), while the non-polymerizable promoters are used to enhance the adhesiveness of only the relatively low modulus compositions (below about 50 MPa). This distinction is significant as it was found that the non-polymerizable adhesion promoters were less effective in the higher modulus compositions. It was further determined that the non-polymerizable silane-containing adhesion promoters cannot be included in compostions that include compounds with acidic functionalities because they form a gel. As many relatively high modulus compositions contain acids to enhance adhesion (e.g., to metals), the non-polymerizable adhesion promoters, and particularly the silanes, are desirably not included in such acid-containing compositions.

Illustrative polymerizable adhesion promoters include CL1039, 4-HBA (4-hydroxybutyl acrylate), SR9008, SR9011, SR9012, SR9016, SR9017, CD9009 and CD9050, FX9801, FX9803, NVP (N-vinyl-2-pyrrolidinone), PVP (2-pyrrolidone-1-ethenyl, homopolymer), organic acids such as acrylic acid, (meth)acrylated acidic adhesion promoters, Y-9389, N-vinyl caprolactam, and mixtures thereof. 4-HBA and acrylic acid are preferred polymerizable adhesion promoters.

Illustrative non-polymerizable adhesion promoters, which are preferably used with the relatively low modulus compositions described herein (no greater than about 50 MPa), include the silanes, advantageously propyl trialkoxy silanes. Preferred silanes are 3-mercaptopropyl trimethoxy silane, gamma-aminopropyltriethoxysilane, 3-aminopropyl trimethoxy silane, and N-(2-aminoethyl)-3-aminopropyl trimethoxy silane, with the aforementioned 3-mercapto silane being preferred. When the silanes are included, the composition is desirably substantially acid-free, i.e., the amount of components with acid functionalities, if any, in the composition is insufficient to cause the silanes to gel.

The adhesion promoter component is desirably present in an amount sufficient to assist in providing the composition, after curing, with an adequate level of adhesion to the targeted substrate material. Generally, the adhesion promoter is present in an amount ranging from about 10 to about 60 wt. % of the curable composition, but is advantageously present from about 20 to about 50 wt. %. Preferably, the promoter is present at from about 25 to about 40 wt. % of the uncured composition.

Advantages are realized when both polymer and non-polymer adhesion promoters are included in the inventive composition, particularly when a single composition is used in the assembly of components made of different materials, e.g., stainless steel, glass fibers and polymers, such as polycarbonate. In this regard, the polymer promoters are desirably present in greater amounts relative to the amount of non-polymerizable promoter, advantageously at least about 2:1 to about 100:1, and preferably about 10:1 to about 50:1. In terms of weight percentages of the uncured composition, the polymerizable promoter may be present at from about 10 wt. % to about 60 wt. %, advantageously from about 20 wt. % to about 50 wt. %, and more preferably from about 25 wt. % to about 40 wt. %. The non-polymerizable promoter may be present at from about 0.1 wt. % to about 10 wt. %, advantageously from about 0.5 wt. % to about 5 wt. %, and preferably from about 1 wt. % to about 4 wt. %. Excessive levels of non-polymer promoters should also be avoided, as the curing of the composition may be compromised.

The dry adhesion of the cured compositions is used as a means of evaluating the adhesive performance of the relatively low modulus compositions. Desirably, the dry adhesion of the cured low modulus compositions is in excess of about 50 g force, preferably is in excess of about 100 g force, and more preferably is in excess of about 150 g force.

The dry adhesion of the foregoing low modulus cured compositions may be determined by drawing down and curing the compositions to be tested onto a glass substrate to provide a film. The film is then cut to provide a series of one-inch wide strips. A portion of each strip is peeled back manually, with the peeled back portion of each strip, in turn, being attached to a testing device (e.g., Instron Model 4201 or equivalent). The test consists of pulling the strips from the glass substrate until the average force value (in grams) becomes constant. This constant value is the gram force (g force) value for the particular strip. An average of the dry adhesion values of at least four strips originating from a single film is used as the dry adhesion of a particular film.

The adhesion of relatively high modulus cured compositions may be determined using a cross hatch test. In this test, a 25 to 75 μm film is drawn over a glass substrate. Perpendicular cuts are made through the film about 1 mm apart, forming a grid. Clear adhesive tape, such as Scotch™ tape, is placed over the grid with hand pressure, and the tape is then removed. Adhesion is determined based upon the number of film squares that adhere to the tape. On a 0 to 2 scale, an adhesion rating of 2 is defined as no squares of the film adhering to the tape, an adhesion rating of 1 is defined as less than 75% of the squares covered by the tape adhering thereto, and an adhesion rating of 0 is defined as greater than 75% of the squares covered by the tape adhering thereto. The inventive cured films desirably possess an adhesion rating of at least 1, and preferably a rating of at least 2.

A further desirable property of the cured inventive compositions is the refractive index. Advantageously, the RI of the cured compositions may be less than about 1.54, advantageously less than about 1.535, and preferably less than about 1.53. For purposes of the present invention, RI may be determined by any suitable means, e.g., by comparing the cured film to refractive index oil standards (e.g., using the Becke line optical phenomenon to determine the extent and direction of any mismatch between to oil and sample).

Optical transmission at 1310 nm and 1550 nm is also desirable. Transmission of greater than 90% of these wavelengths through a 3 mil film is preferably, with a transmission of greater than 95% being more preferable, and at least 99% being most preferable.

The cure speed of the inventive compositions constitutes a further advantageous property. Cure speed may be determined by analyzing a composition's Fourier Transform IR (“FTIR”) curve. The procedure for generating this curve is provided at page 915 of Decker, Kinetic Study of Light-Induced Polymerization by Real-Time UV and IR Spectroscopy, 30 J. Polymer Sci., 913-928, (1992). The curve consists of a correlation of the degree of cure per unit of time, as measured by the percent reacted acrylate unsaturation (% RAU) for the composition undergoing testing, with a higher number indicating a higher degree of cure. Desirably the compositions will cure to 80%RAU in less than 1 second, and preferably to 90% RAU is less than 3 seconds.

In compositions that do not include substantially-colorless dye precursors, colorants, e.g., dyes, pigments and the like, may be included for asthetic or identification purposes. If included, these colorants may be present from about 0.001 to about 10 wt. %, and preferably about 0.1 to about 5 wt. %.

Dyes are preferred because they avoid concerns associated with pigment particle size, pigment dispersion and the like. However, when a dye is used, the amount should be limited so as to avoid any substantial adverse effect on delamination of the cured coating. Illustrative of suitable dyes are polymethine dyes, di- and tri-arylmethine dyes, aza analogues of diarylmethine dyes, aza (18) annulenes (or natural dyes), nitro and nitroso dyes, azo dyes, anthraquinone dyes and sulfur dyes. These dyes are well known in the art.

The dyes, or dye precursors, may also be provided in the form of reactive prepolymers. Preferably, the reactive dye or dye precursor is itself UV-curable, and becomes chemically bonded in the cured coating. Reactive dyes or dye precursors provide cured compositions in which dye migration is reduced, thereby minimizing dye agglomeration in the cured, finished coating. Reactive dyes or dye precursors also reduce dye breakout or extractability in the cured, finished coating.

The reactive dyes and dye precursors can be made by reacting a linking compound, which includes a radiation-curable functionality, with a dye or dye precursor. Similar considerations apply to colorless dyes that will change to a color upon exposure to ultraviolet radiation during cure. The reactive functionality in the dye or dye precursor can be any group that is capable of reacting with a linking group that is used to make the reactive dyes or dye precursors. Illustrative of reactive functionalities that are found in, or can be added to, dyes or dye precursors include, but are not limited to, hydroxyl, amino, including secondary amino, thiol, carboxyl, mercapto, vinyl, acryl, carbamate, or the like.

The linking compound desirably comprises a radiation-curable functionality and a second functionality capable of reacting with the reactive functionality of the dye or dye precursor. Preferably, the radiation-curable functionality is one which can be polymerized through free-radical polymerization.

Another aspect of the present invention provides radiation-curable compositions that enable a user to readily confirm that the radiation-curable composition has been properly cured. These compositions also cure via free-radical polymerization and comprise: an oligomer; a reactive diluent; and a substantially-colorless dye precursor, wherein the composition becomes colored upon exposure to curing radiation.

The foregoing development of coloration during curing occurs as a result of a chemical reaction between the substantially-colorless dye precursor and acid functionalities. Because of this reaction, the composition, prior to curing, is desirably substantially-free of components having acid functionalities, i.e., the concentration of such functionalities, if any, is such that the uncured composition remains substantially color-free. When curing radiation is applied, however, a sufficient concentration of acidic functionalities should be generated to react with the dye precursor, thereby provoking the desired color change therein.

The color-forming system suitable for use in the present invention comprises a substantially-colorless dye precursor. In accordance with the invention, the dye precursor can be any colorless dye which is capable of forming a chromophore in the presence of at least one monomer or oligomer having a radiation-curable functional group which can form free radicals in the presence of actinic radiation and a photoinitiator for the monomer or oligomer and in the presence of a cation.

It will be appreciated by those skilled in the art that the selection of the dye precursor will be dependent on the desired color for the cured coating. For example, if the cured coating is to be green, then the dye precursor is selected so that the chromophore formed during cure is green. Similarly, more than one dye precursor may be included in the coating composition. Use of a mixture allows for a broad spectrum of colors to be achieved in the cured coating.

While not desiring to be bound to any particular theory, suitable dye precursors are those having a lactone functionality.

Illustrative of dye precursors suitable for use in the inventive compositions are dye precursors which have the fluorane structure, preferably, the structure of formula I, as follows:

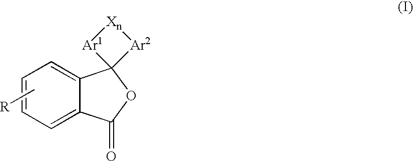

wherein X is oxygen or —NR¹

n is 0 or 1,

R is hydrogen, alkyl, aryl, alkoxy, aryloxy, amino, alkylamino, arylamino or amido, and

R¹ is hydrogen, alkyl or aryl.

Ar¹ and Ar² may be the same or different and are unsubstituted or substituted aryl or unsubstituted or substituted heterocyclic aryl. It will be appreciated by those skilled in the art that when n=0, the aryl groups Ar¹ and Ar² can be fused together, or they can be unfused.

Preferably at least one of Ar¹ and Ar² is substituted with an amino group of the formula —NR²R³, wherein R² and R³ may be the same or different and are hydrogen, alkyl or aryl. The substitution of the —NR²R ³ group on either (or both) Ar¹ or Ar² preferably is at the 3 or 4 position, and most preferably at the 4 position of each of the aryl groups. Copikem™ dyes commercially available from B. F. Goodrich Specialty Chemicals are useful dye precursors.

Thus, suitable dye precursors include leuco dyes, such as isobenzofuranones. Among the isobenzofuranones that are useful in the present invention are 2′phenylamino-3′-methyl-6′(dibutylamino) spiro-[isobenzofuran-1(3H),9′-(9H)-xanthen]-3-one; 2′-di(phenylmethyl)amino-6′-(diethylamino)spiro (isobenzofuran-1(3H),9′-(9H)xanthen)-3-one; 6′-(diethylamino)-3′-methyl-2′-(phenylamino)spiro) isobenzofuran-1(3H), 9′-(9H)xanthen)-3-one; 6-(dimethylamino)3,3-bis(4-dimethylamino)phenyl-1 (3H)-isobensofuranone; and 3,3-bis(1-butyl-2-methyl-1H-indol-3-y 1)-1-(3H)-isobenzofuranone.

Suitable dye precursors also include phthalide-type color formers. Phthalide-type color formers include, for example, diarylmethane phthalides such as those of the formula:

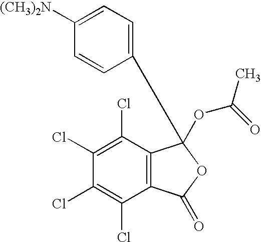

monoarylmethane phthalides such as those of the formula:

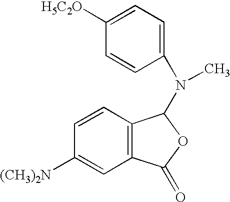

alkenyl substituted phthalides, including, by way of illustration, 3-ethylenyl phthalides of the formula:

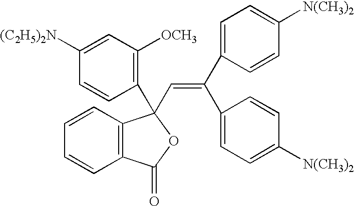

3,3-bisethylenyl phthalides of the formula:

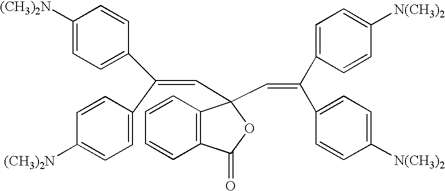

and 3-butadienyl phthalides of the formula:

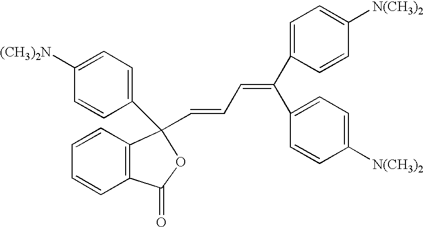

Bridged phthalides, including spirofluorene phthalides such as those of the formula:

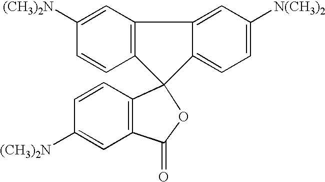

and spirobenzanthracene phthalides such as those of the formula:

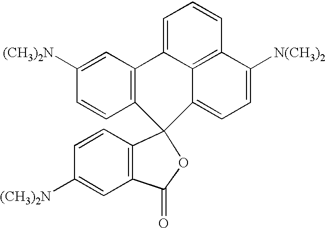

can also be used. Bisphthalides such as those of the formulas:

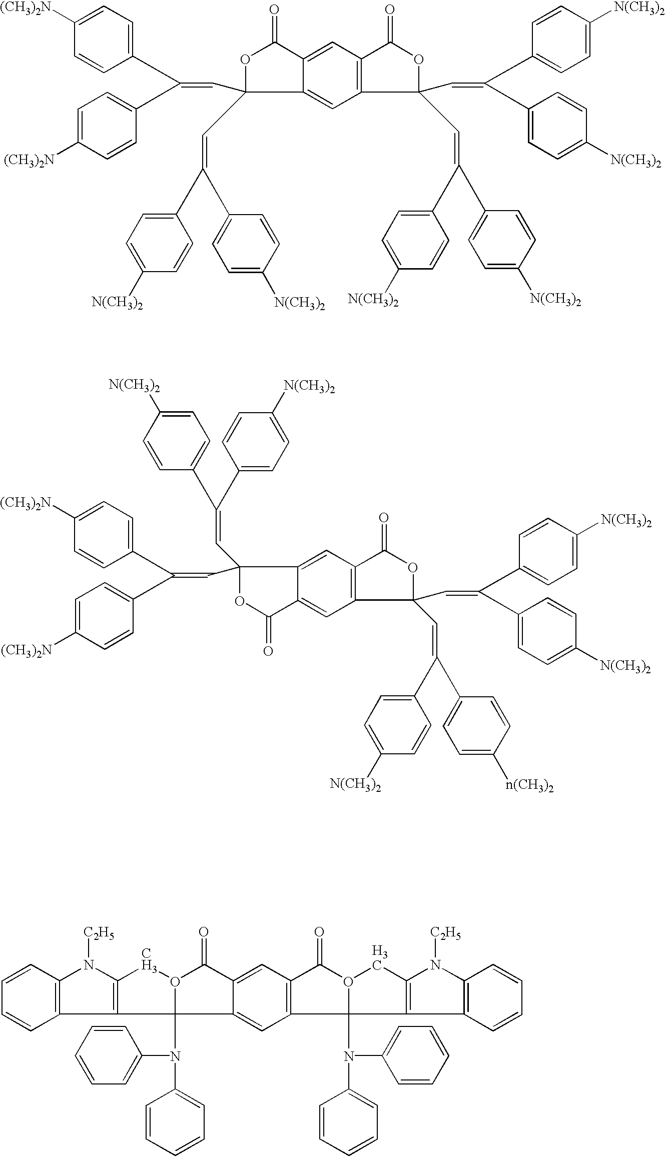

can also be used.

The amount of dye precursor that may be included in the composition may vary according to the desired color intensity in the final product. Generally, however, the dye precursor may be present at from about 0.001 to about 5 wt. %, and preferably at from about 0.01 to about 2 wt. %, based on the weight of the uncured composition.

The inventive composition, upon exposure to curing radiation, should convert the dye precursor to a colored dye, which in turn imparts color to the cured composition. This is desirably accomplished by providing a component in the curable composition that becomes acidic upon exposure to curing radiation. While this may constitute any suitable component, this component, and indeed the curable composition as a whole, should be substantially acid-free prior to exposure of curing radiation to avoid premature conversion of the dye precursor.

Components suitable for inclusion in the present invention that become acidic upon exposure to radiation, specifically UV radiation, include cationic photoinitiators. The inclusion of a cationic photoinitiator as the acid-forming component is counterintuitive in the inventive compositions because the latter cure via free-radical polymerization, and no cationic photoinitiator is required to effect curing of this type of composition.

Cationic photoinitiators are well known, typically comprising onium salts, ferrocenium salts, or diazonium salts. Preferably, aryl sulfonium salts are used, but iodonium salts are also used, both with a variety of counter ions. Upon irradiation with UV radiation, these photoinitiators generate strong acids. Illustrative of cationic photoinitiators suitable for use in the present invention include diaryl iodonium hexafluoroantimonate, triaryl sulfonium hexafluoroantimonate, triaryl sulfonium hexafluorophosphate, and mixtures thereof.

The amount of cationic photoinitiator should be that which will provide sufficient acid to react with the colorless dye, thereby causing the dye, and therefore the cured composition, to become colored. Generally, this amount will be from about 0.1 to about 10 wt. %, advantageously from about 0.5 to about 5 wt. % and preferably from about 1 to about 3 wt. %, based upon the weight of the uncured composition.

One or more photoinitiators that promote free-radical cure are desirably included in the preferred curable compositions. Illustrative photoinitiators include 2-hydroxy-2-methyl-1-phenyl-propan-1-one, a 50:50 blend of 2-hydroxy-2-methyl-1-phenyl-propan-1-one and 2,4,6-trimethylbenzoyl diphenyl phosphine oxide, 1-hydroxycyclohexyl-phenylketone and 2-methyl-1-[4-(methylthio)phenyl]-2-morpholino propan-1-one.

The amount of free-radical photoinitiator should be adjusted relative to the speed at which the acid-providing component, e.g., cationic photoinitiator, becomes acidic upon UV exposure, and thereafter reacts with the substantially-colorless dye precursor. It should be appreciated that the amount of this type of component should be limited so that, when the dye precursor reacts and exhibits color, the composition is also adequately cured. In this way, a person assembling optical comonents, such as photonics devices or splicing optical fibers, is provided with a visual indication as to when the radiation-curable composition is properly cured. A further benefit of the inventive compositions is their ability to indicate when a radiation source is malfunctioning, i.e., a failure of the composition to exhibit the expected degree of coloration after normal exposre times.

Generally, the free-radical photoinitiator may be present in an amount ranging from about 0.1 wt. % to about 15 wt. % of the curable composition, and is preferably present in the range from about 1 wt. % to about 10 wt. % of the composition.

Despite being substantially-free of components having acidic functional groups prior to curing, the cured inventive compositions provide acceptable levels of adhesion to glass, stainless steel and polycarbonate, and in a preferred aspect may be used in the assembly of optical components, e.g., filters, optical fibers, lenses, and the like used in photonic devices. This preferred aspect of the present invention is provided in part by the inclusion of significant amounts of non-acidic polymerizable adhesion promoters, e.g., 4-HBA, (from about 10 to about 60 wt. %, preferably from about 15 to about 40 wt. %, and most preferably from about 20 to about 50 wt. % of the uncured composition) and very limited amounts, if any, of non-polymerizable adhesion promoters (up to about 5 wt. %) based on the uncured composition. A component that adheres well to polycarbonate, e.g., dimethylacrylamide, may also be included in an amount of from about 1 to about 20 wt. %, preferably from about 5 to about 15 wt. %, of the curable composition. The oligomers are desirably present at from about 30 to about 50 wt. %, and preferably from about 35 to about 45 wt. % of the uncured composition.

In another preferred aspect, a recoating composition utilizing the substantially-colorless dye precursors is provided. In this type of composition, one need not include highly adhesive components, in contrast to those components included in adhesive compositions. Further, polycarbonate-adhering components also need not be included, as polycarbonate is not present in optical fibers. Desirably, the oligomers are provided at slightly elevated levels relative to their levels in the adhesive compostions, with reactive diluents constituting a substantial portion of the remaining components. In this regard, the oligomers advantageously constitute about 40 to about 70 wt. %, and preferably from about 50 to about 60 wt. %, of the uncured composition. A multifunctional reactive diluent, preferably a di- or tri-functional diluent, is included to enhance the hardness of the cured composition. This component is advantageously provided in an amount of from about 1 to about 20 wt. %, and preferably from about 5 to about 15 wt. %. A monofunctional reactive diluent, which is preferably aromatic, is desirably provided at from about 10 to about 40 wt. %, and preferably from about 20 to about 30 wt. %, of the uncured composition.

Preferably, the inventive curable compositions are desirably substantially free of components containing epoxy functionalities and other cationically-curing components. This is most preferred in compositions that contain a substantially-colorless dye precursor.

As mentioned, the inventive compositions may be used in connection with the assembly of optical components, e.g., splicing optical fibers and joining various components of photonics devices. A related aspect of the present invention thus contemplates a method for assembling optical components to one another using the inventive compositions described herein.

One such method comprises: (a) applying a UV-curable composition which cures via free radical polymerization between two optical components, the composition comprising: (i) an oligomer, (ii) a reactive diluent, and (iii) a substantially-colorless dye precursor; and (b) exposing the composition to curing radiation, wherein the composition becomes colored upon exposure to curing radiation.

The present invention further contemplates as yet another aspect assembled optical components which include the inventive radiation-curable compositions described herein.

The inventive compositions may optionally contain other components without departing from the scope of the present invention. These components may or may not be radation-curable. For example, surfactants (e.g., LG-99, proprietary, Estron Chemical), stabilizers (e.g., hydroquinone monomethyl ether, BHT, Tetrakis[methylene-(3,5-di-tertbutyl-4-hydroxy-hydrocinnamate)]-methane), and antistatic agents may be included in the compositions.

Curing of the inventive compositions may be accomplished by a variety of means, from hand-held “bond wands” emitting UV radiation at about 4 mW/cm², to devices which emit UV radiation at about 20 mW/cm², to devices which emit UV radiation at a level of at least about 100 mW/cm². While the UV radiation may vary, relatively high intensity radiation is desirable to obtain relatively fast curing of the composition, e.g., in under 30 seconds in the case of optical component assembly operations, and preferably in under 15 seconds, and more preferably in under 10 seconds. Curing within a few seconds is desirable for recoating compositions.

The inventive compositions are further shelf stable for at least one year (at 25° C.), and in the case of the adhesives, are able to cure even when applied between translucent components. The compositions are further non-aqueous.

The objects and advantages of the present invention are further illustrated by the following examples. The particular materials and amounts thereof recited in these examples, as well as the conditions and details, should not be construed as a limitation on the claims of the invention.

### EXAMPLE 1

This example illustrates relatively low modulus UV-curable compositions, both with and without colorants, prepared in accordance with one aspect of the present invention, wherein the compositions (amounts given in wt. % of the uncured composition) are useful as adhesives for the assembly of photonic components.

| Component | A | B | C |
|---|---|---|---|
| Urethane acrylate oligomer | 42 | 41 | 41 |
| (Toluene diisocyanate/hydroxy | | | |
| ethyl acrylate/polypropylene | | | |
| glycol) | | | |
| Dimethylacrylamide | 7 | 7 | 7 |
| Trimethylpropane triacrylate | 0 | 0 | 0 |
| Ethoxylated₄ bisphenol A | 17.9 | 17.9 | 16.9 |
| diacrylate | | | |
| 2-phenoxyethylacrylate ester | 0 | 0 | 0 |
| 4-HBA | 26 | 26 | 26 |
| Difunctional reactive diluent | 0 | 0 | 0 |
| 2,4,6-Trimethylbenzoyldiphenyl- | 2 | 2 | 2 |
| phosphine oxide | | | |
| 2,2-dimethoxy-2-phenyl | 2 | 2 | 2 |
| acetophenone | | | |
| 1-hydroxy-cyclohexyl-phenyl- | 2 | 2 | 2 |
| ketone | | | |
| Cationic photoinitiator | 0 | 0 | 1 |
| 2,2-thioethylene bis-(3,5-di-tert- | 0.1 | 0.1 | 0.1 |
| butyl-4-hydroxyhydrocinnamate | | | |
| 3-mercaptopropyl trimethoxy | 1 | 1 | 1 |
| silane | | | |
| Leuco Crystal Violet | 0 | 1 | 0 |
| Crystal Violet Lactone | 0 | 0 | 1 |
| (Copikem) | | | |
| Total | 100 | 100 | 100 |

In the Table, Composition A includes no dye (for comparison purposes, although being inventive and useful in the methods described herein), and Compositions B and C contain different substantially-colorless dye precursors.

Each composition cured upon exposure to UV radiation, although color change, but no curing, was noted with regard to Composition B after exposure to normal room lighting for 30 minutes (less than about 1 μW/cm²). In contrast, Composition C did not become colored or cure under the foregoing conditions (normal room lighting for 30 minutes), but did become colored and cured upon exposure to radiation at 1 J and 23 mW/cm².

The data indicates that the dye precursor included in Composition B will function in the manner contemplated by the present invention, but must be applied and cured relatively soon (within several minutes) after exposure to daylight (or office light) to obtain the benefits of coloration as a cure indicator. The dye precursor included in Composition C is preferred, as it does not become colored after 30 mins exposure to daylight or office light, but will do so when the composition is exposed to levels of radiation sufficient to cure the composition.

### EXAMPLE 2

This example illustrates relatively low modulus UV-curable compositions prepared both with and without colorants, in accordance with one aspect of the present invention, wherein the compositions (amounts given in wt. % of the uncured composition) are useful as splicing recoat compositions.

| Component | A | B | C |
|---|---|---|---|
| Urethane acrylate oligomer | 60.48 | 59.48 | 59.48 |
| (Toluene diisocyanate/hydroxy | | | |
| ethyl acrylate/polypropylene | | | |
| glycol) | | | |
| Dimethylacrylamide | 0 | 0 | 0 |
| Trimethylpropane triacrylate | 8.1 | 8.1 | 8.1 |
| Ethoxylated₄ Bisphenol A | 0 | 0 | 0 |
| Diacrylate | | | |
| 2-phenoxyethylacrylate ester | 26.32 | 26.32 | 25.32 |
| 4-HBA | 0 | 0 | 0 |
| Difunctional reactive diluent | 0 | 0 | 0 |
| 2,4,6- | 2 | 2 | 2 |
| Trimethylbenzoyldiphenyl- | | | |
| phosphine oxide | | | |
| 2,2-dimethoxy-1,2- | 2 | 2 | 2 |
| diphenylethan-1-one | | | |
| 1-hydroxy-cyclohexyl-phenyl- | 0 | 0 | 0 |
| ketone | | | |
| Cationic photoinitiator | 0 | 0 | 1 |
| 2,2-thioethylene bis-(3,5-di-tert- | 0.1 | 0.1 | 0.1 |
| butyl-4-hydroxyhydro- | | | |
| cinnamate | | | |
| 3-mercaptopropyl trimethoxy | 1 | 1 | 1 |
| silane | | | |
| Leuco Crystal Violet | 0 | 1 | 0 |
| Crystal Violet Lactone | 0 | 0 | 1 |
| (Copikem) | | | |
| Total | 100 | 100 | 100 |

In the Table, Composition A includes no dye (for comparison purposes, although being inventive and useful in the methods described herein), while Compositions B and C contain different substantially-colorless dye precursors.

Each composition cured upon exposure to UV radiation, although color change, but no curing, was noted with regard to Composition B after exposure to normal room lighting for 30 minutes (less than about 1 μW/cm²). In contrast, Composition C did not become colored or cure under the foregoing conditions (normal room lighting for 30 minutes), but desirably did become colored and cured upon exposure to radiation at 1 J and 23 mW/cm².

The data indicates that the dye precursor included in Composition B will function in the manner contemplated by the present invention, but must be applied and cured relatively soon (within several minutes) after exposure to daylight (or office light) to obtain the benefits of coloration as a cure indicator. The dye precursor of Composition C is preferred, as it does not become colored after 30 mins exposure to daylight or office light, but will do so when the composition is exposed to levels of radiation sufficient to cure the composition.

### EXAMPLE 3

This example illustrates UV-curable compositions prepared in accordance with an aspect of the present invention, as well as a comparative prior art composition (Composition 1), wherein the compositions are useful as adhesives and/or recoating compositions, and which do not include a substantially-colorless dye precursor as cure indicator.

| | | | | | | | Comp. |
|---|---|---|---|---|---|---|---|
| Component | A | B | C | D | E | F | 1 |
| Urethane acrylate | 60.48 | 42 | 35 | 62 | 60 | 0 | 62 |
| oligomer A (Toluene | | | | | | | |
| diisocyanate/hydroxy | | | | | | | |
| ethyl acrylate/ | | | | | | | |
| polypropylene glycol) | | | | | | | |
| Urethane acrylate | 0 | 0 | 0 | 0 | 0 | 25 | |
| oligomer B (Toluene | | | | | | | |
| diisocyanate/hydroxy | | | | | | | |
| ethyl acrylate/ | | | | | | | |
| polypropylene | | | | | | | |
| glycol) (lower MW | | | | | | | |
| than oligomer A) | | | | | | | |
| N,N-dimethylacryl- | 0 | 7 | 5 | 5 | 5 | 5 | |
| amide | | | | | | | |
| Acrylic Acid | 0 | 0 | 10 | 0 | 10 | 17 | |
| Tris-(2-hydroxy ethyl) | 0 | 0 | 0 | 0 | 0 | 48 | |
| isocyanurate triacrylate | | | | | | | |
| esters | | | | | | | |
| Trimethyl propane | 8.1 | 0 | 0 | 0 | 0 | 0 | 8.1 |
| triacrylate | | | | | | | |
| Difunctional | 0 | 17.9 | 0 | 0 | 0 | 0 | |
| reactive diluent | | | | | | | |
| Isobornyl acrylate | 0 | 0 | 0 | 0 | 19.4 | 0 | |
| 2-phenoxy- | 26.32 | 0 | 18.9 | 0 | 0 | 0 | 26.32 |
| ethylacrylate ester | | | | | | | |
| 4-HBA | 0 | 26 | 0 | 29.4 | 0 | 0 | |
| Difunctional | 0 | 0 | 22 | 0 | 0 | 0 | |
| reactive diluent | | | | | | | |
| 2,4,6-Trimethyl- | 2 | 2 | 0 | 2.5 | 2.5 | 1.9 | |
| benzoyldiphenyl- | | | | | | | |
| phosphine oxide | | | | | | | |
| 2,2-dimethoxy-2- | 2 | 2 | 2 | 0 | 0 | 0 | 3.12 |
| phenyl acetophenone | | | | | | | |
| 1-hydroxy-cyclohexyl- | 0 | 2 | 4 | 0 | 0 | 0 | |
| phenyl ketone | | | | | | | |
| Phenothiazine | | | | | | | 0.1 |
| 2,2-thioethylene | 0.1 | 0.1 | 0.1 | 0.1 | 0.1 | 0.1 | |
| bis-(3,5-di-tert- | | | | | | | |
| butyl-4-hydroxyhydro- | | | | | | | |
| cinnamate | | | | | | | |
| 3-mercapto- | 1 | 1 | 0 | 1 | 0 | 0 | |
| propyl trimethoxy | | | | | | | |
| silane | | | | | | | |
| Methacrylated | 0 | 0 | 3 | 0 | 3 | 3 | |
| acidic adhesion | | | | | | | |
| promoter | | | | | | | |
| DC190 | | | | | | | 0.2 |
| Modulus | 44 | 17 | 800 | 6.7 | 728 | 2020 | 50 |
| Equilibrium Modulus | 12 | 10 | 15 | 6 | 7 | 60 | 12 |
| Dry Adhesion | 255 | 326 | 164 | NA | NA | NA | 13.9 |
| Weight Loss (%) | 3 | 1 | 2 | 1 | 2 | NA | |
| After 85° C./85% RH | | | | | | | |
| for 4 Weeks | | | | | | | |
| Adhesion Rating to | 2 | 2 | 2 | 2 | 2 | 1 | 2 |
| Polycarbonate | | | | | | | |
| Adhesion to Glass | 1 | 2 | 2 | 2 | 2 | 2 | 0 |
| Adhesion to Stainless | 0 | 1 | 2 | 2 | 2 | 2 | 0 |
| Steel | | | | | | | |
| FTIR 80% (secs) | 0.5 | 0.15 | 1 | 0.1 | 0.15 | 0.5 | 1 |
| FTIP 90% (secs) | 2 | 1 | 2 | 0.15 | 1 | 2 | 3 |
| Transmission (%) | 99 | 99 | 99 | 99 | 99 | 99 | 99 |
| 1310 nm | | | | | | | |
| Transmission (%) | 99 | 99 | 99 | 99 | 99 | 99 | 99 |
| 1550 nm | | | | | | | |
| Cured Film RI | 1.537 | 1.53 | 1.537 | 1.532 | 1.531 | 1.528 | 1.55 |
| TOTAL | 100 | 100 | 100 | 100 | 100 | 100 | 100 |

In this example, the modulus was determined using an Instron 4201 at a crosshead speed setting of 1 inch/min.

Any patents and articles referenced herein are incorporated by reference. Further, any reference herein to a component in the singular is intended to indicate and include at least one of that particular component, i.e., one or more.

Novel and improved coating compositions and fiber optics coated with such compositions have been provided by the present invention which exhibit enhanced properties as compared to existing compositions and coated fibers. Various additional modifications of the embodiments specifically illustrated and described herein will be apparent to those skilled in the art, particularly in light of the teachings of this invention. The invention should thus not be construed as limited to the specific form and examples as shown and described, but instead as is set forth in the following claims.

We claim:

1. A radiation-curable composition that cures via free-radical polymerization comprising:
about 30 to about 70 wt. % oligomer;
about 10 to about 50 wt. % reactive diluent; and
about 0.1 to about 40 wt. % adhesion promoter, wherein the cured composition exhibits a modulus of less than about 50 MPa and a dry adhesion in excess of about 50 g force.

2. The radiation-curable composition according to claim 1, wherein the adhesion promoter comprises a non-polymerizable adhesion promoter.

3. The radiation-curable composition according to claim 2, wherein the cured composition exhibits a dry adhesion in excess of about 100 g force.

4. The radiation-curable composition according to claim 2, wherein the non-polymerizable adhesion promoter comprises a silane compound.

5. The radiation-curable composition according to claim 4, wherein the silane compound is selected from the group consisting of 3-mercaptopropyl trimethoxy silane, gamma-aminopropyltriethoxysilane, 3-aminopropyl trimethoxy silane, N-(2-aminoethyl)-3-aminopropyl trimethoxy silane, and mixtures thereof.

6. The radiation-curable composition according to claim 1, further comprising a colorant.

7. The radiation-curable composition according to claim 8, wherein the colorant is a dye.

8. The radiation-curable composition according to claim 8, wherein the colorant is a reactive dye or a reactive dye precursor.

9. The radiation-curable composition according to claim 6, wherein the colorant is a dye precursor that is substantially-colorless prior to curing of the composition.

10. The radiation-curable composition according to claim 9, further comprising a cationic photoinitiator that becomes acidic upon exposure to curing radiation.

11. The radiation-curable composition according to claim 9, wherein the dye precursor remains substantially-colorless after exposure to no more than about 1 μW/cm³ for 30 minutes.

12. The radiation-curable composition according to claim 1, further comprising a substantially-colorless dye precursor, a non-polymerizable adhesion promoter, and wherein the cured composition exhibits a dry adhesion of at least about 100 g force.

13. The radiation-curable composition according to claim 1, wherein the composition cures to 90% RAU in less than 3 seconds.

14. The radiation-curable composition according to claim 1, wherein the adhesion to glass is at least 1.

15. The radiation-curable composition according to claim 14, wherein the adhesion to stainless steel is at least 1.

16. The radiation-curable composition according to claim 15, wherein the adhesion to glass is at least 2.

17. A radiation-curable composition that cures via free-radical polymerization comprising:
about 30 to about 70 wt. % oligomer;
about 10 to about 50 wt. % reactive diluent; and
about 0.1 to about 40 wt. % adhesion promoter,
wherein the cured composition exhibits a modulus of at least about 600 MPa and has a glass adhesion rating of at least 1.

18. The radiation-curable composition according to claim 17, wherein the adhesion promoter comprises a polymerizable adhesion promoter.

19. The radiation-curable composition according to claim 18, wherein the polymerizable adhesion promoter is a component having an acrylate functional group or an acid functional group.

20. The radiation-curable composition according to claim 18, wherein the adhesion promoter further comprises a non-polymerizable adhesion promoters.

21. The radiation-curable composition according to claim 20, wherein the non-polymerizable adhesion promoter comprises a silane compound.

22. The radiation-curable composition according to claim 20, wherein the weight ratio of polymerizable to non-polymerizable adhesion promoter ranges from about 2:1 to about 100:1.

23. The radiation-curable composition according to claim 21, wherein the silane compound is a propyl trialkoxy silane.

24. The radiation-curable composition according to claim 17, further comprising a colorant.

25. The radiation-curable composition according to claim 24, wherein the colorant is a dye.

26. The radiation-curable composition according to claim 24, wherein the colorant is a reactive dye or a reactive dye precursor.

27. The radiation-curable composition according to claim 24, wherein the colorant is a dye precursor that is substantially-colorless prior to curing of the composition.

28. The radiation-curable composition according to claim 27, further comprising a cationic photoinitiator that becomes acidic upon exposure to curing radiation.

29. The radiation-curable composition according to claim 17, wherein the dye precursor remains substantially-colorless after exposure to no more than about 1 μW/cm³ for 30 minutes.

30. The radiation-curable composition according to claim 17, wherein the composition cures to 90% RAU in no more than 2 seconds.

31. The radiation-curable composition according to claim 17, further comprising a substantially-colorless dye precursor, a polymerizable adhesion promoter, and wherein the cured composition exhibits a glass adhesion rating of at least 2.

32. The radiation-curable composition according to claim 17, wherein the uncured composition is substantially free of acidic components.

33. The radiation-curable composition according to claim 17, wherein the cured composition exhibits a glass adhesion rating of at least 2.

34. The radiation-curable composition according to claim 17, wherein the cured composition exhibits a stainless steel adhesion rating of at least 1.

35. The radiation-curable composition according to claim 33, wherein the cured composition exhibits a stainless steel adhesion rating of at least 2.

36. The radiation-curable composition according to claim 17, wherein at least 20 wt. % of the composition comprises oligomers, reactive diluents or a combination thereof possessing a plurality of radiation-curable functionalities.

37. A method for the assembly of optical components comprising:
(a) applying a UV-curable composition which cures via free-radical polymerization between two optical components, the composition comprising:
(i) about 30 to about 70 wt. % oligomer;
(ii) about 10 to about 50 wt. % reactive diluent; and
(iii) about 0.1 to about 40 wt. % adhesion promoter,
(b) exposing the composition to curing radiation, wherein the cured composition exhibits a modulus of less than about 50 MPa and a dry adhesion in excess of about 50 g force.

38. The method according to claim 37, wherein the adhesion promoter comprises a non-polymerizable adhesion promoter.

39. The method according to claim 37, wherein the cured composition exhibits a dry adhesion in excess of about 100 g force.

40. The method according to claim 37 wherein the non-polymerizable adhesion promoter comprises a silane compound.

41. The method according to claim 37, further comprising a colorant.

42. The method according to claim 41, wherein the colorant is a dye.

43. The method according to claim 41, wherein the colorant is a dye precursor.

44. The method according to claim 43, wherein the dye precursor is substantially-colorless prior to curing of the composition.

45. The method according to claim 44, further comprising a cationic photoinitiator that becomes acidic upon exposure to curing radiation.

46. The method according to claim 37, wherein the adhesion to glass is at least 1.

47. The method according to claim 46, wherein the adhesion to stainless steel is at least 1.

48. The method according to claim 47, wherein the adhesion to glass is at least 2.

49. A method for the assembly of optical components comprising:
(a) applying a UV-curable composition which cures via free-radical polymerization between two optical components, the composition comprising:
(i) about 30 to about 70 wt. % oligomer;
(ii) about 10 to about 50 wt. % reactive diluent; and
(iii) about 0.1 to about 40 wt. % adhesion promoter,
(b) exposing the composition to curing radiation,
wherein the cured composition exhibits a modulus of at least about 600 MPa and has an adhesion rating of at least 1.

50. A method for the assembly of optical components comprising:
(a) applying a UV-curable composition which cures via free-radical polymerization between two optical components, the composition comprising:
an oligomer;
a reactive diluent; and
a substantially-colorless dye precursor,
(b) exposing the composition to curing radiation,
wherein the composition becomes colored upon exposure to curing radiation.

51. An assembly of optical components prepared using a composition comprising:
about 30 to about 70 wt. % oligomer;
about 10 to about 50 wt. % reactive diluent; and
about 0.1 to about 40 wt. % adhesion promoter,
wherein the cured composition exhibits a modulus of at least about 600 MPa and has an adhesion rating of at least 1.
